(19) United States
(12) Patent Application Publication
(10) Pub. No.: US 2014/0074909 A1
(43) Pub. Date: Mar. 13, 2014

(54) MANAGING CONVERSATIONS IN SINGLE VIEW PANE ENVIRONMENT

(71) Applicants: Nathan Gunderson, Seattle, WA (US); Russell Alexander, Seattle, WA (US); James Andrew Canitz, Kirkland, WA (US); Kris Durgin, Seattle, WA (US); Christina Marie Meyer, Seattle, WA (US); Joshua Hinds, Seattle, WA (US); Leslie Cindy Chen, Bellevue, WA (US); Eric Hamilton, Bothell, WA (US); Marcelo Truffat, Woodinville, WA (US)

(72) Inventors: Nathan Gunderson, Seattle, WA (US); Russell Alexander, Seattle, WA (US); James Andrew Canitz, Kirkland, WA (US); Kris Durgin, Seattle, WA (US); Christina Marie Meyer, Seattle, WA (US); Joshua Hinds, Seattle, WA (US); Leslie Cindy Chen, Bellevue, WA (US); Eric Hamilton, Bothell, WA (US); Marcelo Truffat, Woodinville, WA (US)

(73) Assignee: Microsoft Corporation, Redmond, WA (US)

(21) Appl. No.: 13/615,585

(22) Filed: Sep. 13, 2012

(51) Int. Cl. G06F 15/16

(52) U.S. Cl. 709/203

(57) ABSTRACT

A communication application displays a conversation navigation bar to manage conversations. The application inserts an interactive tile into the navigation bar for each conversation. Each tile presents status information about the conversation and the modality of the conversation. Tiles are ordered according to activity and updates. The navigation bar is adjustable to accommodate hardware and software limitations of a platform.

### BACKGROUND

Computer applications interact with human beings through user interfaces. While audio, tactile, and similar forms of user interfaces are available, visual user interfaces through a display device are the most common form of user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications render visual effects through a display and enable users to provide input associated with the applications' operations.

Lack of traditional control devices may force modern touch based platforms to limit presented extensive control structures, menus, and view panes. In traditional environments, developers partitioned presentation of real time communications across multiple view panes. Resource limitations in mobile platforms restrict modern communication solutions to simplified interfaces. Simplified interfaces have trouble replicating the feature rich functionality of traditional solutions. Screen area limitations enforce strict limits on developers on what features to port from desktop applications. Optimizing control surfaces to accommodate limitations of touch based hardware while expanding functionality to encompass desktop features becomes a goal to achieve in order to satisfy customer demand in modern touch based solutions.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to managing conversations in a single view pane environment. According to some embodiments, a communication application may display a conversation navigation bar managing conversations. The application may display conversations as dynamic tiles in the navigation bar. Each tile may display a variety of conversation information including modality and status. Next, the application may detect a conversation activity. The activity may include an update to an existing conversation, for example. Alternatively, the activity may include addition of a new conversation. The application may integrate the activity to the navigation bar. The application may insert a new conversation into the navigation bar as an active tile while displaying modality and status information. An update to an existing conversation such as activation status may be reflected on the corresponding tile through an alert or modality and status information change. Subsequently, the application may order the conversations according to the activity. The application may move an active conversation tile to a primary position. Updated conversation tiles may be moved behind the active conversation tile while open and unchanged tiles are pushed back in order.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example network diagram where a communication application may manage conversations in a single view pane environment according to some embodiments;

FIG. 2 illustrates example scenarios of adding conversations to a conversation navigation bar according to embodiments;

FIG. 3 illustrates example scenarios of updating existing conversations in another conversation navigation bar according to embodiments;

FIG. 4 illustrates an example application utilizing the conversation navigation bar on a user interface of a tablet device according to embodiments;

FIG. 5 illustrates an example application utilizing the conversation navigation bar on a user interface of a smart phone device according to embodiments;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process managing conversations in a single view pane environment according to embodiments.

### DETAILED DESCRIPTION

As briefly described above, a communication application may manage conversations in a single view pane environment. The application may insert and order new conversation tiles to add new conversations and update existing conversation tiles to reflect updates to existing conversations. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

According to embodiments, a conversation navigation bar may be an application control to manage multiple conversations. The navigation bar may enable interactivity with multiple conversations through tile controls. A tile control or a tile may be an interactive user interface element containing indicators to inform a user about the status of the conversation. The tile may also be selectable to enable the user to manage the conversation. A selected tile may bring a conversation to an active status or provide additional controls to manage other features of the conversation such as status, participants, etc. The tile may further display modality and status information. A tile may be an active tile for an ongoing conversation, an open tile for an open but non-active conversation, or an updated tile for an open conversation that received an update. Modality may include audio, video, text, sharing, combinations, etc. Status information may display the status of the conversation such as active, open, on hold, inactive, etc. Status information may also include data about the participants such as the participants identity, presence information, etc. The navigation bar may display one tile per conversation, ordered according to activity and update status of the conversation. The navigation bar may be scrollable to accommodate screen size limits of a display device.

Throughout this specification, the term “platform” may be a combination of software and hardware components for managing conversations in a single view pane environment. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

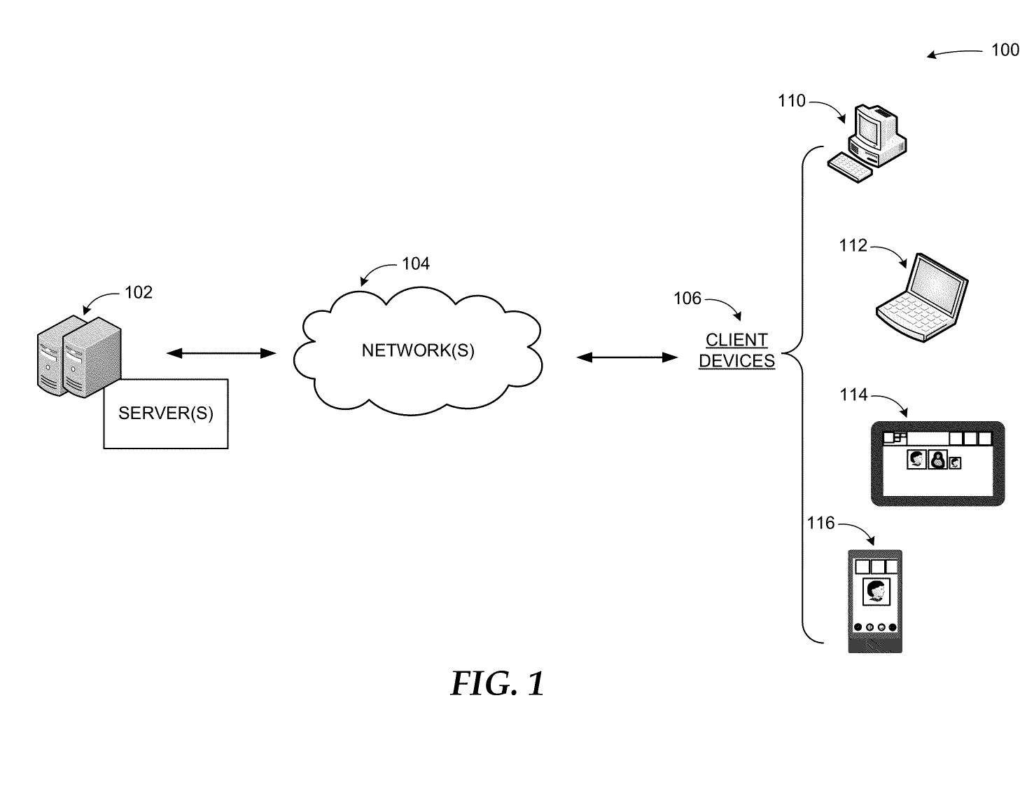

Referring to FIG. 1, diagram 100 illustrates an example network diagram where a communication application may manage conversations in a single view pane environment according to some embodiments. The components and environments shown in diagram 100 are for illustration purposes. Embodiments may be implemented in various local, networked, cloud-based and similar computing environments employing a variety of computing devices and systems, hardware and software.

In an example environment illustrated in diagram 100, one or more client devices may host a communication application to establish one or more conversations. The conversations may include a variety of modalities including audio, video, text messaging, sharing, etc. The modalities may include combinations such as video and text messaging, video and sharing. etc. The communication application may automatically determine modality of a conversation according to hardware and software capabilities of one of the client devices 106. In an example scenario, the communication application executing in smart phone 116 may initiate an audio conversation with tablet 114 because of network restrictions preventing sufficient bandwidth to establish a video conversation. In another example scenario, the application may update the modality of the conversation when the network restrictions are removed. An example may be the smart phone 116 connecting to a wireless local area network (WLAN), removing bandwidth limitations of a cellular network, for example, and initiating a video conversation.

Additionally, the application may adjust its user interface according to detected capabilities of the client devices 106. The application may display a conversation navigation bar with a full feature set when executing in hardware such as desktop 110 or laptop 112 with expanded hardware features such as large screen display. However, the application may minimize displayed features when executing in a limited hardware such as tablet 114 and smart phone 116, which may have restrictions on screen size. In an example scenario, the application may display a scrollable conversation navigation bar in tablet 114 and smart phone 116. A scrollable navigation bar may hide some tiles to accommodate screen size limitations while still providing full feature set to the user. In addition, the communication application executing on client devices 106 may communicate through network(s) 104 which may include a network with a wired, a wireless, or a combination architecture.

Examples above describe the communication application in a peer to peer architecture. Alternatively, the communication application may work in a client/server architecture. The communication application may execute in server(s) 102 to manage conversations in client devices 106. A client application component of the server application may execute in devices 110-116 to provide a user interface and connectivity to the server application. Embodiments of a communication application may not be limited to peer to peer or client/server architectures. A communication application may be implemented through hybrid, multi-tier, thin-client, thick-client, and other architectures.

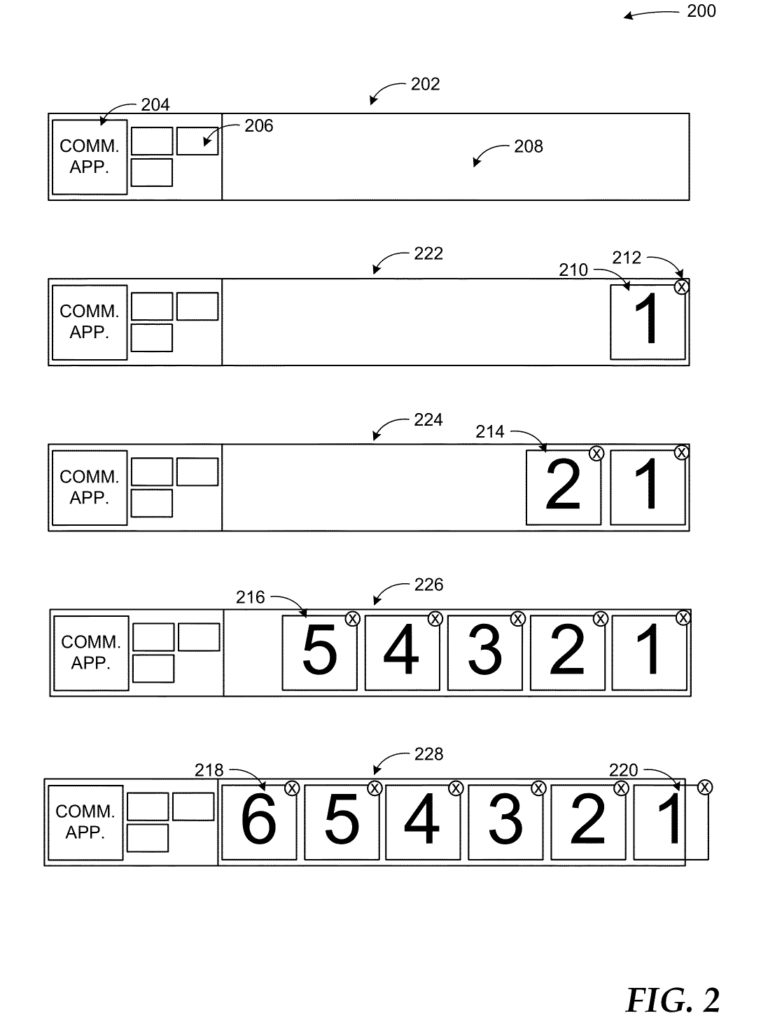

FIG. 2 illustrates example scenarios of adding conversations to a conversation navigation bar according to embodiments. Diagram 200 displays example conversation navigation bars adding conversation tiles for new conversations.

A communication application, according to embodiments, may display a conversation navigation bar 202. The navigation bar 202 may display identifier tile 204 showing the communication applications name as well as notifications, which may alert a user about the status of the application. In an example scenario, the tile 204 may display a highlight color to inform the user about activity or lack activity within the communication application.

The navigation bar 202 may have controls 206. The controls 206 may adjust various functionality of a conversation such as start/stop conversation, change modalities, increase/decrease volume, mute, turn on/off camera, etc. The navigation bar 202 may also have pane 208 encompassing conversation tiles. In an initial state with no established conversations, the application may display an empty pane 208.

When a user starts a conversation, the application may display a tile 210 representing the conversation in navigation bar 222. The tile may have a close button 212 to enable the user to turn off the conversation. In response to the user starting another conversation, the application may add another tile 214 to the navigation bar 224. The new tile 214 may represent an active conversation. The application may display the active tile representing 214 the active conversation in front of other tiles representing open conversations.

According to some embodiments, the application may fill the navigation bar 226 with conversation tiles. The active tile 216 may be placed in front of other tiles representing open conversations.

The application may yet add further tiles to represent additional conversations started by the user in navigation bar 228. The application may fill the available space in the navigation bar 228 with conversation tiles and place the new tile representing the active conversation tile 218 in front of the open tiles. In addition, the application may make the navigation bar scrollable in response to adding more conversation tiles than available screen size in the navigation bar 228. The application may enable the user to select any one of the active and open tiles by scrolling right or left through user actions including swiping left or right.

The application may sort the tiles from left to right while placing active tile(s) in the primary position on the left by default. Alternatively, the application may present the navigation bar in a mirror orientation compared to default position of the controls. During such an alternate presentation of the navigation bar, the application may sort the tiles from right to left while placing the active tile in the primary position on the right.

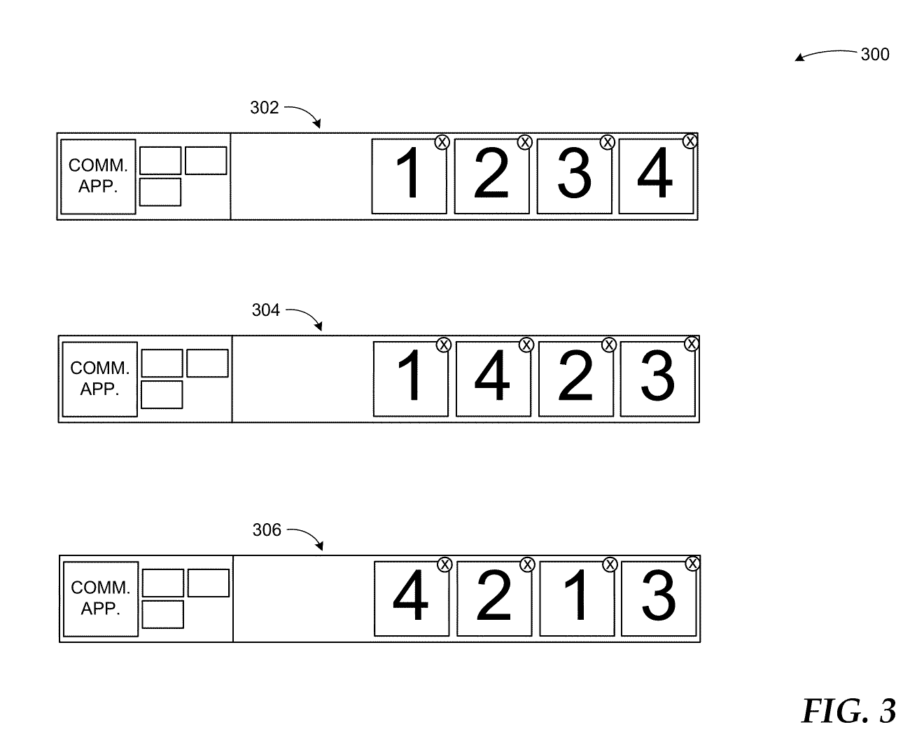

FIG. 3 illustrates example scenarios of updating existing conversations in another conversation navigation bar according to embodiments. Diagram 300 displays example navigation bars updating conversation tiles.

Initially, the application may display a navigation bar 302, which may show one active conversation tile “1” followed by open conversation tiles. One of the open conversations tiles “4” may receive an update and be moved to a position behind the active tile “1” in navigation bar 304. The update may be a status or modality change of the open conversation. An example may include a participant sending a text message through an audio conversation.

The tile “4” may display the updated text message on the tile or display a notification indicating a new message from the participant. The notification may be a highlight of the updated tile “4” or a flashing color indicator to notify the user of the updated tile “4.” The visual indicator may be turned off in response to the user taking an action on the updated tile “4”, and the action may include the user selecting the updated tile “4.” The visual indicator may be a pulse animation that may have an adjustable length and duration according to the corresponding activity such as an update and an activated conversation.

When the user activates an open conversation by selecting an open conversation tile “4”, the application may move the newly activated tile “4” to front position in navigation bar 306. In some embodiments, the application may only allow one active conversation for modalities such as audio and video. In such scenarios, the application may idle the existing active conversation and move the tile “1” representing the idle conversation behind the active conversation tile “4”.

The application may also update the status of open conversation “2.” Since, the tile “2” has an updated status, the application may sort the tiles to put updated tile “2” behind active conversation tile “4” within navigation bar 306. Any inactive or closed conversations may be placed in conversation history accessible through another control on the conversation navigation bar.

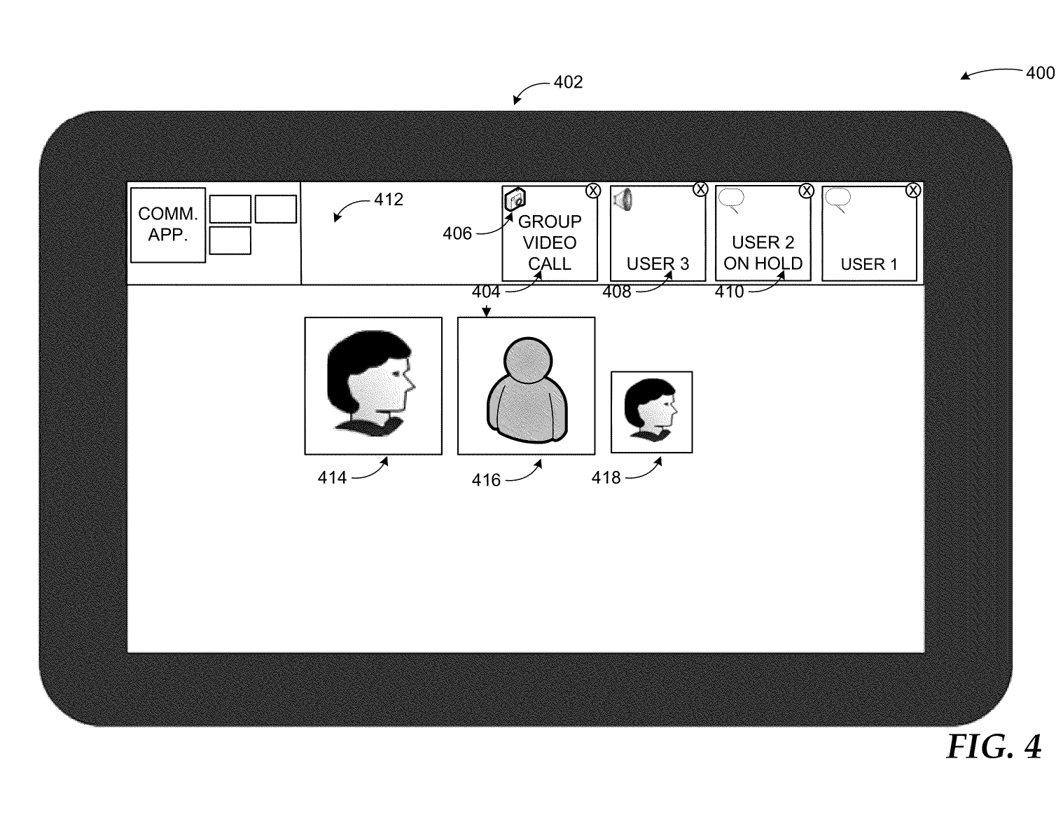

FIG. 4 illustrates an example application utilizing the conversation navigation bar on a user interface of a tablet device according to embodiments. Diagram 400 shows a tablet device 402 executing a communication application displaying a conversation navigation bar 412.

The communication application may display navigation bar 412 with conversation tiles to control multiple conversations. A conversation tile 404 may display a modality icon 406 indicating a video conference with a group. The conversation tile 404 may be the active conversation participated by the user.

The open tile 408 may indicate a phone conversation with another participant who may be partaking in the conference without video. The tile 408 may identify the participant with a message on the tile. Yet another conversation tile 410 may identify the participant while also indicating the status of the conversation. The conversation may be open but on hold. The tile 410 may also display a modality icon indication text message based conversation. A tile may also indicate a presence status of a participant through a notification such as a highlight color. In an example scenario, the participant identification text may glow green for a present participant or glow red for a participant who is inactive.

The application may also display user and participant panes showing video, picture, or a graphic representation of the user and participants. The application may display the user 418 in a minimized pane while displaying participants in larger panes 414 and 416. Activation of a tile and corresponding conversation may change the components displayed by the application such as user panes displaying video streams of the user and participants, or a pane displaying shared user and participant items.

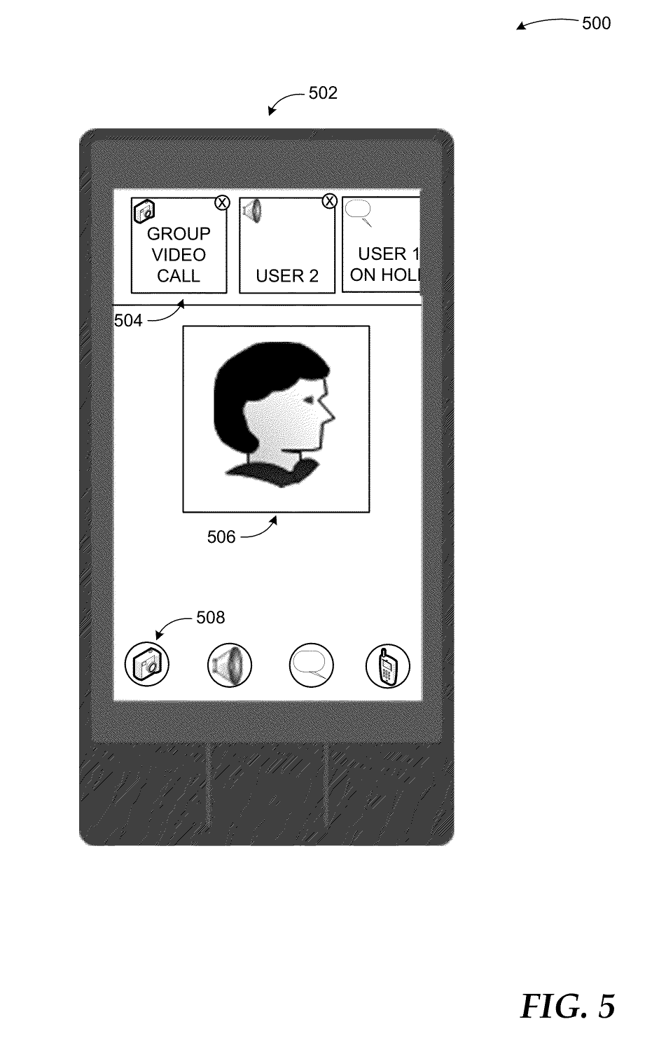

FIG. 5 illustrates an example application utilizing the conversation navigation bar on a user interface of a smart phone according to embodiments. Diagram 500 shows a smart phone 502 executing a communication application displaying a navigation bar 504.

The application may display a simplified navigation bar 504 to accommodate limited screen space provided by the smart phone platform. The application may only display conversation tiles to represent active and open conversations. The navigation bar 504 may be scrollable to select conversation tiles hidden from the screen and bring them to focus. The application may also display a participant pane 506 to identify the current participant in the active conversation tile. The participant pane 506 may display a video stream, an image, or a graphic representation such as an icon representation of the participant.

In addition, the application may also display controls 508 associated with modalities of a conversation. In response to activation of one of the controls 508, the application may start new conversations associated with a modality such as video, audio, text messaging, conferencing, etc. The controls 508 may also be used to display conversations matching a modality displayed on one of the controls. An example may be the application displaying only video conference conversation tiles when a user selects a control associated with video modality.

Embodiments are not limited to described modalities and navigation bar examples. Conversation tiles may be sorted according to update time. Additionally, more than one active conversation may be displayed in the navigation bar. In such a scenario, the navigation bar may sort the active tiles in descending order according to sharing, video, audio, text messaging, and voicemail modalities from left to right. The updated tiles may be ordered from left to right according to last update time, with the latest updated tile positioned in the front. As stated before, the application may mirror the navigation bar according to a user preference, in which case the sorting may be replaced with a right to left order. In addition, the application may display contact information prompt in response to detecting a user action continually stimulating a conversation tile. The contact information prompt may display name, address, phone number, email address, organization position, and presence information of the participant of the conversation associated with the stimulated tile. Furthermore, the application may display only tiles for conversations initiated by the user. Additionally, the orientation of the navigation bar may not be limited to right to left or left to right. The navigation bar may be displayed in any orientation with tiles sorted according to the orientation such as top down, bottom up, spherical, etc.

The example scenarios and schemas in FIG. 2 through 5 are shown with specific components, data types, and configurations. Embodiments are not limited to systems according to these example configurations. Managing conversations in a single view pane environment may be implemented in configurations employing fewer or additional components in applications and user interfaces. Furthermore, the example schema and components shown in FIG. 2 through 5 and their subcomponents may be implemented in a similar manner with other values using the principles described herein.

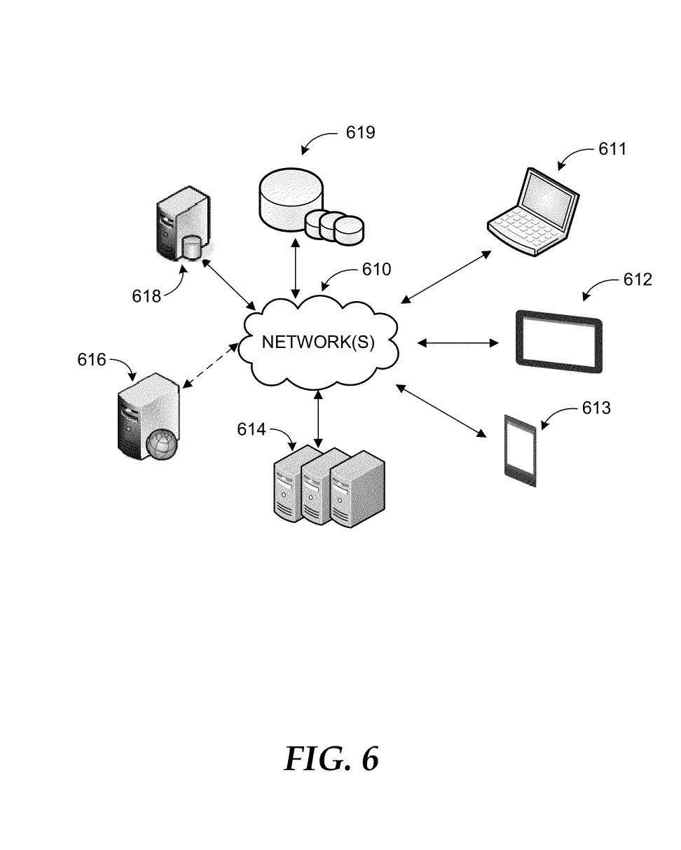

FIG. 6 is a networked environment, where a system according to embodiments may be implemented. Local and remote resources may be provided by one or more servers 614 or a single server (e.g. web server) 616 such as a hosted service. A communication application may communicate with client interfaces on individual computing devices such as a smart phone 613, a tablet device 612, or a laptop computer 611 (‘client devices’) through network(s) 610.

As discussed above, a communication application may manage conversations in a single view pane environment. The application may display a navigation bar sorting conversation tiles according to activity and updates. The application may display update information on the tiles. Client devices 611-613 may enable access to applications executed on remote server(s) (e.g. one of servers 614) as discussed previously. The server(s) may retrieve or store relevant data from/to data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to manage conversations in a single view pane environment. Furthermore, the networked environments discussed in FIG. 6 are for illustration purposes only. Embodiments are not limited to the example applications, modules, or processes.

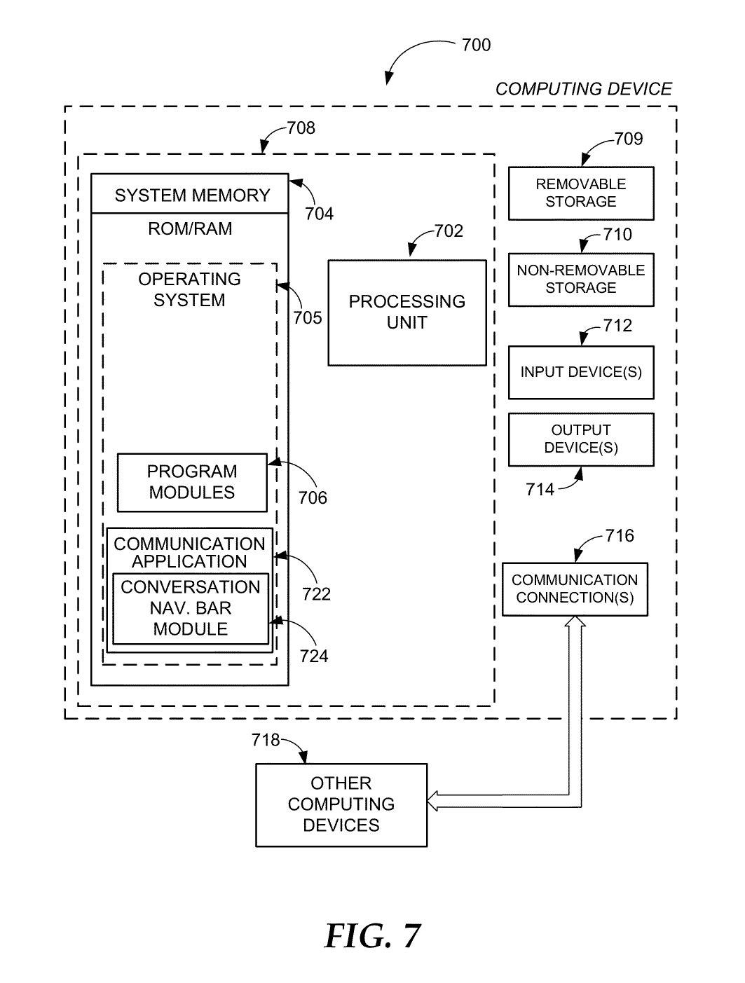

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® and WINDOWS PHONE® operating systems from MICROSOFT CORPORATION of Redmond, Wash. The system memory 704 may also include one or more software applications such as program modules 706, a communication application 722, and a conversation navigation bar module 724.

The communication application 722 may provide a display surface of a device with a conversation navigation bar to manage conversation tiles according to embodiments. The conversation navigation bar module 724 may configure and update the conversation tiles according to activity and updates. Examples may include positioning an active tile representing a new conversation in front while placing an updated conversation tile adjacent to the active tile. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. Computer readable storage media is a computer readable memory device. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wireless network in a distributed computing environment, a satellite link, a cellular link, and comparable mechanisms. Other devices 718 may include computer device(s) that execute communication applications, storage servers, and comparable devices. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

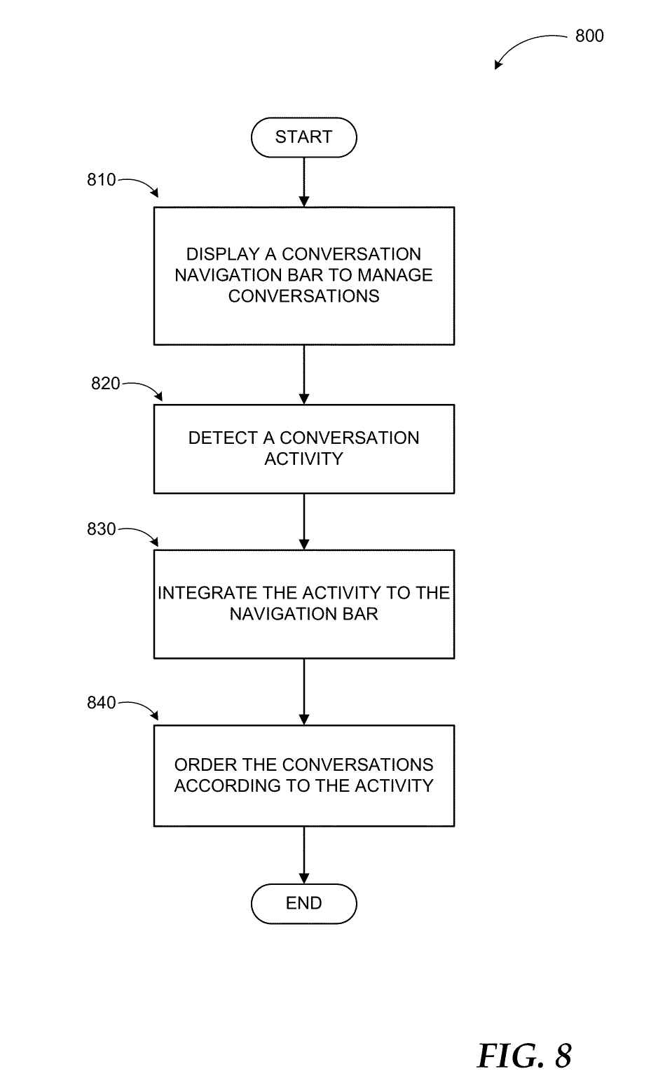

FIG. 8 illustrates a logic flow diagram for a process managing conversations in a single view pane environment according to embodiments. Process 800 may be implemented by an application such as a communication application in some examples.

Process 800 may begin with operation 810 where a communication application may display a conversation navigation bar managing conversations. The application may display a tile for each open conversation. The application may detect a conversation activity at operation 820. The activity may include a new conversation, an update to an open conversation, and a closed conversation.

The application may integrate the activity to the navigation bar at operation 830. The application may place a new conversation tile as an active tile in front of other open conversation tiles. The application may order the conversations according to the activity at operation 840. Activated open conversation tiles are placed in front as active tiles. Furthermore, the application may apply the update to an associated tile and place the updated tile adjacent to the active tile. Conversations associated with closed tiles are sent to conversation history.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 800 are for illustration purposes. Managing conversations in a single view pane environment according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for managing conversations in a single view pane environment, the method comprising:
displaying a conversation navigation bar managing the conversations through representative graphics for each conversation;
detecting a conversation activity;
integrating the activity to the navigation bar by modifying one or more representative graphics of conversations affected by the activity; and
ordering the representative graphics according to the activity.

2. The method of claim 1, further comprising:
presenting the representative graphics for each conversation as tiles.

3. The method of claim 2, further comprising:
displaying at least one of: a modality indicator and a status indicator in the tiles.

4. The method of claim 3, further comprising:
inserting a new conversation as an active tile in front of existing tiles.

5. The method of claim 4, further comprising:
updating at least one of: the modality indicator and the status indicator of a tile in response to an update to an open conversation; and
placing the updated tile adjacent to the active tile.

6. The method of claim 2, further comprising:
partitioning the tiles to: active tiles for active conversations, updated tiles for open and updated conversations; and open and non-active tiles for open and non-active conversations.

7. The method of claim 2, further comprising:
storing conversations associated with closed tiles in conversation history.

8. The method of claim 2, further comprising:
ordering the tiles according to the activity by:
placing active tiles representing active conversations in front,
placing updated tiles representing updated conversations adjacent to the active tiles, and
placing open and non-active tiles representing open and non-active conversations behind the updated tiles.

9. The method of claim 8, further comprising:
ordering each set of the active, updated, open and non-active tiles according a modality order of: desktop sharing, video, audio, text messaging, and voicemail.

10. The method of claim 9, further comprising:
ordering the updated tiles according to a time of update with a last updated tile placed first among the updated tiles.

11. The method of claim 2, further comprising:
limiting displayed tiles to tiles associated with conversations started by a user of a communication application displaying the navigation bar.

12. A computing device for managing conversations in a single view pane environment, the computing device comprising:
a memory configured to store instructions; and
a processor coupled to the memory, the processor executing a communication application in conjunction with the instructions stored in the memory, wherein the communication application is configured to:
display a conversation navigation bar managing the conversations through a plurality of tiles representing the conversations, wherein the tiles include one or more of a modality indicator and a status indicator;
detect a conversation activity;
integrate the activity to the navigation bar by one or more of:
inserting a new conversation as an active tile, and
updating an open conversation tile to an updated tile in response to an update to an open and non-active conversation; and
order the tiles according to the activity by placing: the active tile in a primary position, the updated tile adjacent to the active tile, and another open and non-active tile representing another open and non-active conversation adjacent to the updated tile.

13. The computing device of claim 12, wherein the application is further configured to:
display notifications in the active and updated tiles to alert a user to an active conversation and the update to the open and non-active conversation.

14. The computing device of claim 13, wherein the application is further configured to:
utilize a pulse animation as at least one of the notifications; and
adjust a length and a duration of the pulse animation according to the activity.

15. The computing device of claim 12, wherein the application is further configured to:
provide scroll functionality in the navigation bar to bring tiles hidden from view into focus if screen size available to the application is limited.

16. The computing device of claim 14, wherein the application is further configured to:
detect a user action selecting one of the tiles; and
display a contact information prompt about a participant associated with the selected tile.

17. A computer-readable memory device with instructions stored thereon for managing conversations in a single view pane environment, the instructions comprising:
displaying a conversation navigation bar managing the conversations through a plurality of tiles representing the conversations, wherein the tiles include one or more of a modality indicator and a status indicator;
detecting a conversation activity;
integrating the activity to the navigation bar by one or more of: inserting a new conversation as an active tile and updating an open conversation tile to an updated tile in response to an update to an open and non-active conversation;
ordering the tiles according to the activity by placing: the active tile in a primary position, the updated tile adjacent to the active tile, and another open and non-active tile representing another open and non-active conversation adjacent to the updated tile; and
displaying notifications in the active and updated tiles to alert a user to an active conversation and the update to the open and non-active conversation.

18. The computer-readable memory device of claim 17, wherein the instructions further comprise:
reversing a sort order of the tiles upon a communication application changing an orientation of the navigation bar to a mirror orientation.

19. The computer-readable memory device of claim 17, wherein the instructions further comprise:
activating one of the conversations in response to activation of a corresponding one of the tiles.

20. The computer-readable memory device of claim 17, wherein the instructions further comprise:
indicate a presence status of a participant through a notification on a participant identification displayed on at least one of the tiles.
